(19) United States
(12) Patent Application Publication
(10) Pub. No.: US 2010/0107806 A1
(43) Pub. Date: May 6, 2010

(54) Vehicle Steering-Wheel Cover

(76) Inventors: Alessandro Alcide Gino Benvenuto Corinaldi, Milano (IT); Antonio Volontieri, Legnano (IT); Marco Sorze, Rozzano (IT)

Correspondence Address: NIXON & VANDERHYE, PC, 901 NORTH GLEBE ROAD, 11TH FLOOR, ARLINGTON, VA, 22203, US

(21) Appl. No.: 11/922,950

(22) PCT Filed: Jan. 26, 2007
(86) PCT No.: PCT/IT2007/000054

§ 371 Date: Dec. 27, 2007

(51) Int. Cl. B62D 1/04; B60Q 1/00

(52) U.S. Cl. 74/552; 340/438

(57) ABSTRACT

The present invention addresses a vehicle steering-wheel cover comprising a body and a support element having a predetermined profile, said support element being associated to said body. The characterizing feature of the present invention is that diffuser means for diffusing a light emitted from at least one light source, as well as electronic control means for controlling said light source to obtain a visual effect in response to data concerning the status of the vehicle are interposed between said body and said support element.

The present invention relates to a vehicle steering-wheel cover, particularly, but without limitation, to a cover for an airbag device of a vehicle steering-wheel, according to the preamble of claim 1.

Airbag devices are widely used in the automotive industry, as passive safety systems that can be installed in steering-wheels, dashboards, seats and/or roof panels of automotive vehicles.

In its most common application, the airbag is a fabric bag, e.g. made of Kevlar, which is located in a housing in the central part of the steering-wheel.

In the event of a violent crash of the vehicle, the central part of the front wall of this housing is designed to violently break open upon airbag triggering, to prevent the driver from striking the steering column.

While such airbag device provides unquestionable advantages for the passive safety of drivers, it still prevents visually convenient installation of devices designed to warn the driver about the vehicle operating status.

Automotive warning devices are usually located in the instrument panel, dashboard and/or central dashboard column.

Nevertheless, it is a fact that the driver has to look away from the road to read the indications on such warning devices, and focus attention on the device to read the proposed information.

This action can cause the driver to be distracted as he/she drives, and lead to crashes, with easily imaginable consequences.

Particularly, the presence of an airbag device prevents the central part of the steering-wheel, i.e. the part that is designed to violently break open as the airbag is triggered, from being used to hold the above mentioned devices for warning about the vehicle operating status.

Thus, a need is strongly felt in the automotive industry to utilize the central part of the front wall of the airbag housing.

The invention is based on the issue of conceiving a steering-wheel cover, and more particularly a cover for an airbag device of a vehicle steering-wheel, that has such structural and functional features as to fulfill the above need.

This issue is addressed by a vehicle steering-wheel cover as defined in claim 1.

The present invention provides a steering-wheel cover, more particularly a cover for an airbag device, that can promptly warn the driver about the vehicle operating status.

Further features and advantages of the vehicle steering-wheel cover of this invention will be apparent upon reading the following description of one preferred embodiment thereof, which is given by way of illustration and without limitation with reference to the accompanying figures, in which:

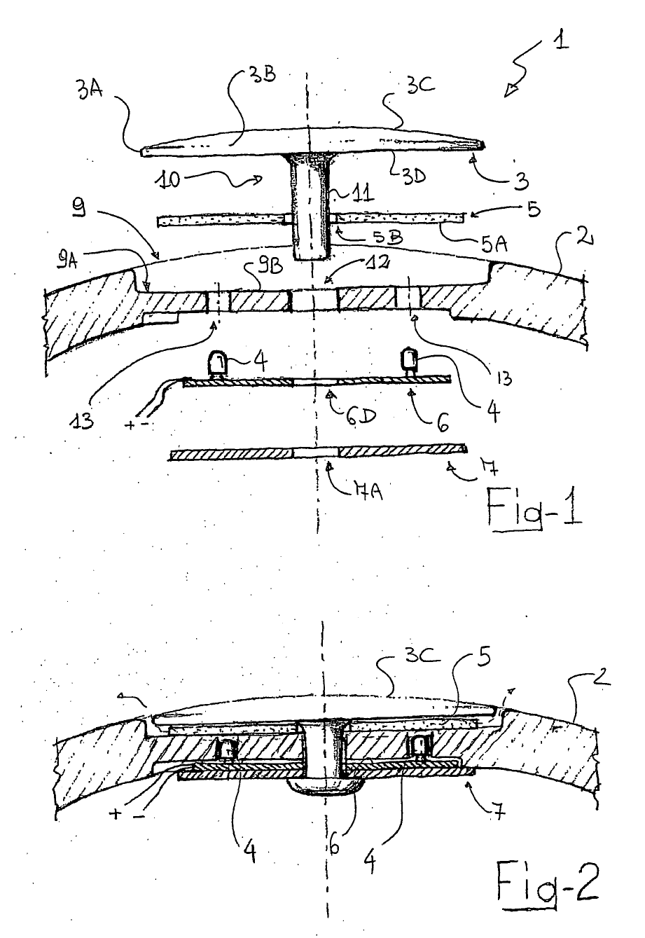

FIG. 1 is a sectional exploded view of a steering-wheel cover, more particularly of a cover for an airbag device of a vehicle steering-wheel, according to the present invention;

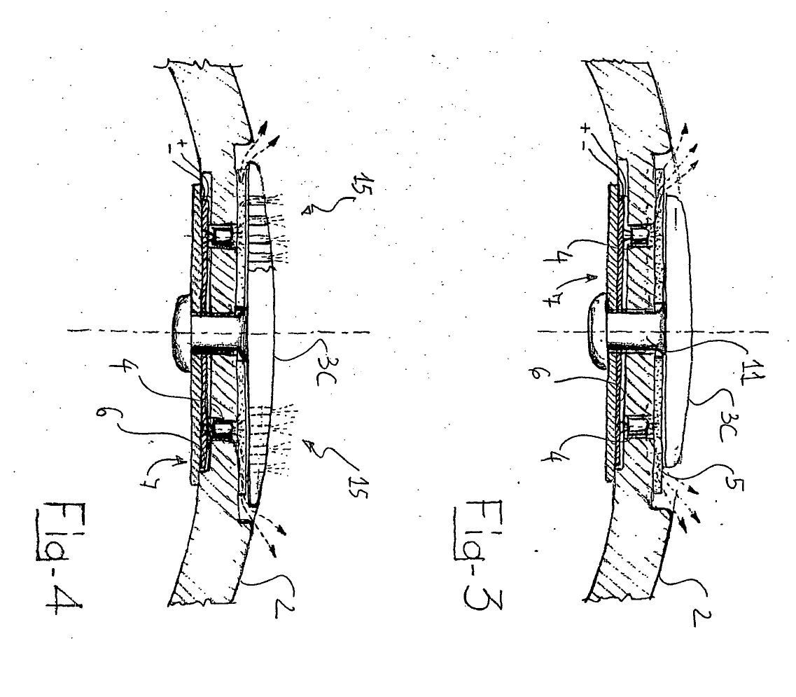

FIG. 2 is a sectional view of the cover of FIG. 1, with the elements held in the vehicle steering-wheel cover, more particularly in the cover for an airbag device of a vehicle steering-wheel, according to the present invention;

FIG. 3 is a sectional view of an alternative embodiment of the cover of FIG. 1, with the elements held in the vehicle steering-wheel cover, more particularly in the cover for an airbag device of a vehicle steering-wheel, according to the present invention;

FIG. 4 is a sectional view of another embodiment of the cover of FIG. 1, with the elements held in the vehicle steering-wheel cover, more particularly cover for an airbag device of a vehicle steering-wheel, according to the present invention;

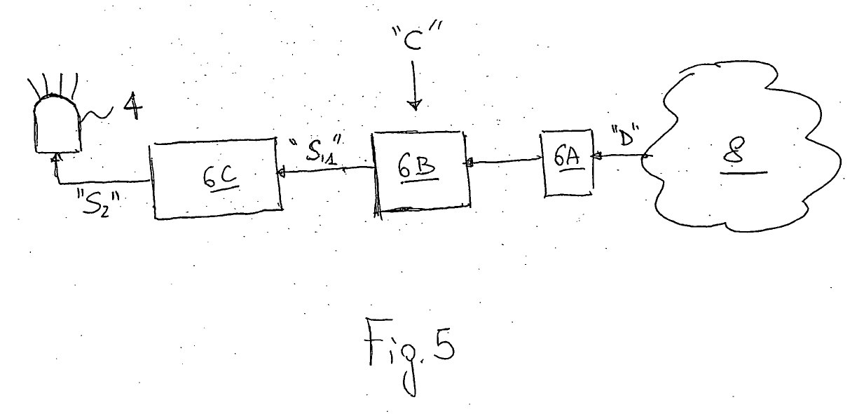

FIG. 5 shows a basic wiring diagram for the control of one of the elements that form the vehicle steering-wheel cover, more particularly the cover for an airbag device of a vehicle steering-wheel, according to the present invention;

Referring to the annexed figures, numeral 1 generally designates a cover for a vehicle steering-wheel (not shown), more particularly a cover for an airbag device, which is usually held in a vehicle steering-wheel.

In accordance with the present invention, the cover 1 comprises:
a body 2,
a support element 3 having a predetermined profile, e.g. a circular, rhomboidal egg-, shield-shaped profile and/or the like,
at least one light source 4,
diffuser means 5 for diffusing light emitted from the light source 4,
electronic control means 6 for controlling the light source 4, and
a plate 7.

Particularly referring to FIGS. 2 to 4, which shows the above elements held in the vehicle steering-wheel cover, it can be appreciated that the support element 3 is associated to the body 2 and that the diffuser means 5 and the electronic control means 6 are interposed between said body 2 and said support element 3.

Advantageously, the electronic control means 6 can control the light source 4 to obtain a visual effect in response to specific data “D” concerning the status of a vehicle 8, to promptly warn the driver about the operating status of the vehicle.

For this purpose, with further reference to FIG. 5, which shows a possible wiring diagram, the electronic control means 6 comprise a data acquisition interface 6A, a microprocessor 6B and a control device 6C, wherein said data acquisition interface 6A can receive data “D” concerning the status of the vehicle 8, said microprocessor 6B can process said data “D” to generate a processed signal “S₁” according to predetermined control criteria “Cᵢ” and said control device 6C can receive said processed signal “S₁” to generate a control signal “S₂” for controlling said light source 4 according to said control criteria “Cᵢ”.

It shall be noted that such FIG. 5 only shows the elements required to understand the operation and implementation of the present invention. Those skilled in the art will understand which additional elements are required, and how they have to be designed, implemented and connected with the illustrated elements to form a complete wiring diagram of the electronic control means 6.

For instance, a person of ordinary skill in the art will be able to supply the electronic control means 6 with appropriate voltages and currents.

Advantageously, the control signal “S₂” is an electric signal appropriately modulated to control said light source 4 to obtain a visual effect in response to said data “D” concerning the status of the vehicle 8.

In one embodiment of the present invention, the data acquisition interface 6A is envisaged as a digital data acquisition interface, that can interface with the data channel (not shown) for the data “D” of the vehicle 8, for acquiring said data “D” concerning the vehicle status.

In this case, the data “D” is digital data and interfacing with the data transmission channel requires knowledge of the transmission protocol used by the manufacturer of the vehicle 8.

Alternatively, the data acquisition interface 6A is an analogue data acquisition interface, that can directly acquire the value of predetermined electric quantities, such as voltage and/or current, at specific points of the electric circuit of the vehicle, such as the ignition switch, courtesy lights and/or the like, said electric quantities being representative of said data “D” concerning the status of the vehicle 8.

In another embodiment (not shown), the data acquisition interface 6A is a radio-based data acquisition interface that can remotely acquire said data “D” concerning the status of the vehicle 8.

For this purpose, suitable transponders may be used for remote acquisition of the data “D”. This solution is particularly suitable for use when assembly of dedicated cables is difficult.

For example, if the data “D” include instantaneous speed, average speed, instantaneous fuel consumption, average fuel consumption, abnormal condition warning and/or the like and the control criterion C provides the generation of a “fade-in” visual effect, then the microprocessor 6B shall process the data “D” in such a manner as to generate a specific processed signal “S₁” so that the control device 6C can in turn generate a suitable control signal “S₂” which is an electric signal modulated to fade the light source 4 from off to on with a preset speed.

In other words, the control signal “S₂” is an electric signal modulated to gradually increase the intensity of the light source 4 with appropriate frequency.

Still considering that the data “D” include the data listed above, if the control criterion C provides the generation of a “fade-out” visual effect, then the control signal “S₂” will be an electric signal modulated to fade the light source 4 from on to off with a preset speed, to gradually decrease its intensity.

It shall be noted that in the above “C” control cases, the microprocessor 6B can control the light source 4 to vary among a plurality of colors, for instance in sixteen-million-color palette.

However, if the control criterion “C” provides the generation of a blinking visual effect, then the control signal “S₂” will be an electric signal modulated to cause the light source 4 to blink with a preset frequency, such as 0.5 sec.

For example, in the latter control condition “C”, the light source 4 may blink between two states, off-color or color-color, with the color possibly varying among a plurality of colors.

Those skilled in the art may obviously envisage other types of functionally equivalent control criteria “C” instead of the above control criteria “C”.

For example, other control criteria “C” may include:
adjusting the intensity of the light source 4 among a plurality of intensity levels, e.g. among 256 values;
providing a psychedelic effect of the light source 4, in which the light source 4 blinks and changes color to the rhythm of music transmitted from the vehicle radio.

Referring now to FIG. 1, the body 2 comprises a receptacle 9, with a bottom 9A, which is conformed to receive the support element 3 and the diffuser means 5.

It can be appreciated, particularly from FIGS. 2, 3 and 4, that the support element 3 and the diffuser means 5 are packed together to safely prevent them from coming out of the body 2.

It should be noted that the support element 3 has a front wall 3A, i.e. the wall exposed to the driver's view, with a receptacle 3B in which an emblem 3C is firmly associated and a rear wall 3D, i.e. the wall hidden from the driver's view, with engagement means 10 for connecting said support element to said body 2.

Particularly, as shown in such FIGS. 2 to 4, the diffuser means 5 may be packed against the rear wall 3B, e.g. using a glue, and are in surface contact with the bottom 9A of the receptacle 9.

Those skilled in the art may obviously envisage other types of functionally equivalent materials instead of the glue.

Particularly, the engagement means 10 include a stem 11 projecting from said rear wall 3D of said support element 3 and the plate 7 in which a hole 7A is made.

As shown in FIG. 1, the bottom 9A of the receptacle 9 has a front wall 9B and a rear wall 9C and a first aperture 12 extending from said front wall 9B and said rear wall 9C of the bottom 9A of the receptacle 9 of said body 2.

It shall be particularly noted that the stem 11 extends through said aperture 12 of said body 2 and through said hole 7A of said plate 7, as well as through a hole 5B formed in the diffuser means 5 and, optionally, through a hole formed in the electronic control means 6.

In other words, the holes 5A, 6A and 7A and the first aperture 12 are formed in their respective elements in aligned positions.

To prevent removal of the support element 3 and the diffuser means 5, the stem 11 has an end portion 11A riveted over the plate 7.

In a preferred embodiment of the present invention, in the proximity of the front wall 9B of the bottom 9A of the receptacle 9, the bottom 9A has a second aperture 13 for receiving the light source 4 so that the light emitted by said at least one light source 4 may come out through said second aperture 13.

As shown in FIGS. 2, 3 and 4, the light source 4 is wholly contained within the thickness of the receptacle 9.

It shall be further noted that the body 2 has a housing 14 in which the electronic control means 6 are located, within the thickness of said body 2, at the bottom wall 9C of the bottom 9A of the receptacle 9.

As shown in the embodiment of such FIG. 2, the profile of the diffuser means 5 is contained in the profile of the support element 3.

It shall be noted that the electronic control means 6 consist of a flexible Printed Circuit Board (PCB) whose thickness allows it to be located in the housing 14, e.g. is less than 0.5 mm, preferably 0.2 mm.

Alternatively, the engagement means 10 include a plurality of crimping means (not shown) which, according to a preferred embodiment, are peripheral tabs projecting out of the rear wall 3D of the support element 3.

Particularly, the plurality of peripheral tabs may extend through the diffuser means 5 and are folded back against the rear wall 5A of the diffuser means 5 during assembly.

Referring now to FIG. 3, which shows a different embodiment of the present invention, the profile of the diffuser means 5 extends beyond the profile of the support element 3.

Thus, the peripheral profile of the diffuser means 5 projects out of the peripheral profile of the support element 3.

For example, in the embodiment of this figure, if the profile of the support element 3 is substantially circular, then the diffuser means 5 will also have a substantially circular (or disk) profile, and the part of the peripheral profile of the diffuser means 5 beyond the peripheral profile of the support element 3 forms a ring (or toroid) surrounding the support element 3.

Referring now to FIG. 4, which shows a further different embodiment of the present invention, at least one portion of the support element 3 and the corresponding portion of the emblem 3C have a plurality of microholes 15 for transmitting the light emitted from the light source 4 also through said support element and said emblem.

It should be noted that the support element 3 and the emblem 3C are formed of sheet metal, such as aluminum.

It should be further noted that the diffuser means 5 include a monolithic element which is made of a material selected from the group consisting of transparent polycarbonate and opaline.

For example, the monolithic element may have a thickness in a range from 0.3 to 10 mm, preferably from 0.5 to 1.5 mm.

The monolithic element may be processed to obtain polished and/or satin-finished surfaces, e.g. at the outer surface or at the surface of the hole 5B, which are designed to selectively enhance or reduce light transmission through the plastic element.

In this respect, it shall be noted that a film diffuser may be also applied to said monolithic plastic element, to obtain a composite plastic element that can provide selective light transmission through the plastic element.

In a preferred embodiment, the light source 4 may be a LED, or a group of LEDs, of single-color and/or RGB, i.e. multicolor type.

The group of LEDs comprises multiple LED sources, such as a number of 2 to 16 LEDs.

In the embodiments described above and shown in FIGS. 2 to 4, the elements have been disposed in the receptacle 9 of the body 2 in such an arrangement that the surface of the emblem 3C, i.e. the surface exposed to the driver's view, seamlessly continued the surface of the body 2 over said receptacle 9. As an alternative, the diffuser means 5 and the support element 3 with the emblem 3C attached thereto may extend below or above the imaginary line that continues the surface of the body 2 over said receptacle 9.

As clearly shown in the above description, the vehicle steering-wheel cover, more particularly the cover for an airbag device of a vehicle steering-wheel according to the present invention fulfills the above mentioned need and also obviates prior art drawbacks as set out in the introduction of this disclosure.

Those skilled in the art will obviously appreciate that a number of changes and variants may be made to the vehicle steering-wheel cover as described hereinbefore, in response to specific requirements, without departure from the scope of the invention, as defined in the following claims.

1. Vehicle steering-wheel over (1) comprising a body (2) and a support element (3) having a predetermined profile, said support element (3) being associated to said body (2), characterized in that diffuser means (5) for diffusing a light emitted from at least one light source (4), as well as electronic control means (6) for controlling said light source (4) to obtain a visual effect in response to data (D) concerning the status of the vehicle (8) are interposed between said body (2) and said support element (3).

2. A vehicle steering-wheel cover as claimed in claim 1, wherein said electronic control means (6) comprise a data acquisition interface (6A), a microprocessor (6B) and a control device (6C), said data acquisition interface (6A) being adapted to receive said data (D) concerning the status of the vehicle (8), said microprocessor (6B) being adapted to process said data (D) to generate a processed signal (S₁) according to predetermined control criteria (C) and said control device (6C) being adapted to receive said processed signal (S₁) to generate a control signal (S₂) for controlling said light source (4) according to said control criteria (C).

3. A vehicle steering-wheel cover as claimed in claim 2, wherein said control signal (S₂) is an electric signal appropriately modulated to control said light source (4) to obtain a visual effect in response to said data (D) concerning the status of the vehicle (8).

4. A vehicle steering-wheel cover as claimed in claim 2 or 3, wherein said control signal (S₂) is an electric signal modulated to fade said light source (4) from off to on with a preset speed, thereby providing a fade-in visual effect.

5. A vehicle steering-wheel cover as claimed in claim 2 or 3, wherein said control signal (S₂) is an electric signal modulated to fade said light source (4) from on to off with a preset speed, thereby providing a fade-out visual effect.

6. A vehicle steering-wheel cover as claimed in claim 2 or 3, wherein said control signal (S₂) is an electric signal modulated to cause said light source (4) to blink with a preset frequency, thereby providing a blinking visual effect.

7. A vehicle steering-wheel cover as claimed in claims 2 to 6, wherein said data acquisition interface (6A) is a digital data acquisition interface, that can interface with the data channel of the vehicle, for acquiring said data (D) concerning the status of the vehicle (8).

8. A vehicle steering-wheel cover as claimed in claims 2 to 6, wherein said data acquisition interface (6A) is an analogue data acquisition interface, that can directly acquire the value of predetermined electric quantities at specific points of the electric circuit of the vehicle, said electric quantities being representative of said data (D) concerning the status of the vehicle (8).

9. A vehicle steering-wheel cover as claimed in claims 2 to 6, wherein said data acquisition interface (6A) is a radio-based data acquisition interface for remotely acquiring said data (D) concerning the status of the vehicle (8).

10. A vehicle steering-wheel cover as claimed in claims 1 to 9, wherein said data (D) concerning the status of the vehicle include instantaneous speed, average speed, instantaneous fuel consumption, average fuel consumption and/or abnormal condition warning.

11. A vehicle steering-wheel cover as claimed in claims 1 to 10, wherein said body (2) comprises a receptacle (9), with a bottom (9A), which is conformed to receive said support element (3) and said diffuser means (5) in a packed configuration.

12. A vehicle steering-wheel cover as claimed in claim 11, wherein said support element (3) has a front wall (3A), with a receptacle (3B) in which an emblem (3C) is firmly associated and a rear wall (3D), with engagement means (10) for connecting said support element (3) to said body (2).

13. A vehicle steering-wheel cover as claimed in claim 12, wherein said engagement means (10) comprise a stem (11), projecting from said rear wall (3D) of said support element (3) and a plate (7) in which a hole (7A) is made.

14. A vehicle steering-wheel cover as claimed in claims 11 to 13, wherein said bottom (9A) of said receptacle (9) has a front wall (9B) and a rear wall (9C) and a first aperture (12) extending from said front wall (9B) and said rear wall (9C), said stem (11) extending through said first aperture (12) of said body (2) and through said hole (7A) of said plate (7), said stem (11) having an end portion (11A) riveted over said plate (7) to prevent removal of said support element (3).

15. A vehicle steering-wheel cover as claimed in claims 11 to 14, wherein, in the proximity of said front wall (9B) of the bottom (9A) of said receptacle (9), said bottom (9A) has a second aperture (13) for receiving said light source (4) so that the light emitted by said at least one light source (4) and intercepted by said diffuser means (5) comes out through said second aperture (13).

16. A vehicle steering-wheel cover as claimed in claims 11 to 15, wherein said body (2) has a housing (14) in which said electronic control means (6) are located, at said bottom wall 9C of the bottom (9A) of said receptacle (9).

17. A vehicle steering-wheel cover as claimed in claims 1 to 16, wherein said diffuser means (5) extend beyond said profile of said support element (3).

18. A vehicle steering-wheel cover as claimed in claim 12, wherein said engagement means (10) comprise a plurality of crimping means, projecting out of said rear wall (3D) of said support element (3).

19. A vehicle steering-wheel cover as claimed in claim 18, wherein said plurality of crimping means, extend through said diffuser means (5).

20. A vehicle steering-wheel cover as claimed in any preceding claim wherein, if said profile of said support element (3) is substantially circular, then said diffuser means (5) will also have a substantially circular profile.

21. A vehicle steering-wheel cover as claimed in claim 12, wherein at least one portion of said support element (3) and the corresponding portion of said emblem (3C) have a plurality of microholes (15) for transmitting the light emitted from said light source (4) also through said support element (3) and said emblem (3C)

22. A vehicle steering-wheel cover as claimed in any preceding claim, wherein said light source includes a LED, or a group of LEDs, of single-color and/or RGB type.

23. A vehicle steering-wheel cover as claimed in any preceding claim, wherein said support element (3) is made of sheet metal.

24. A vehicle steering-wheel cover as claimed in any preceding claim, wherein said diffuser means (5) include a monolithic element which is made of a material selected from the group consisting of transparent polycarbonate and opaline, said monolithic element having a thickness in a range from 0.3 to 10 mm, preferably from 0.5 to 1.5 mm.

25. A vehicle steering-wheel cover as claimed in claim 24, wherein a film diffuser is applied to said monolithic element.

26. A vehicle steering-wheel comprising a cover as claimed in any one of claims 1 to 25.

27. A vehicle steering-wheel as claimed in claim 26, wherein said cover is a cover (1) for an airbag device.
